(19) United States
(12) Patent Application Publication
(10) Pub. No.: US 2022/0143652 A1
(43) Pub. Date: May 12, 2022

(54) SELECTION MACHINE FOR WASTE PRODUCTS AND SELECTION METHOD

(71) Applicant: PAL S.R.L., Ponte Di Piave (IT)

(72) Inventor: Michele Libralato, Quinto di Treviso (IT)

(73) Assignee: PAL S.R.L., Ponte Di Piave (IT)

(21) Appl. No.: 17/435,936

(22) PCT Filed: Mar. 5, 2020
(86) PCT No.: PCT/IT2020/050050

§ 371 Date: Sep. 2, 2021

(30) Foreign Application Priority Data
Mar. 5, 2019 (IT) 102019000003177

(51) Int. Cl. B07C 5/342; B07C 5/36

(52) U.S. Cl. CPC B07C 5/342; B07C 2501/0054; B07C 5/368

(57) ABSTRACT

Selection machine for wood-type waste products to produce panels which comprises a delivery hopper and a conveyor belt on which a flow of wood material to be selected advances.

### FIELD OF THE INVENTION

The present invention concerns improvements to selection machines for loose and incoherent waste products, as well as the corresponding selection method.

More specifically, the improvements concern selection machines for wood-type waste products, contaminated by components whose specific weight is in the range of the specific weight of wood, such as rigid plastics, rubbers, melamine-coated wood, plastic, paper.

The product resulting from the selection has to be suitable to produce panels for industrial use, mainly but not only for making furniture, or suchlike, in particular MDF panels of wood fiber. In fact, while a chipboard panel is not particularly affected by the presence of plastic pollutants, rubbers, plastic and melamine coatings, especially for the central layer (it is a panel with at least 3 layers) an MDF panel cannot have plastic residues on its surface, otherwise there is the risk, during the subsequent finishing, of leaving craters caused by the swelling of the plastic/rubber with heat. The invention therefore aims to overcome the current state of the art which provides that the MDF (medium density fiber) panel is made with virgin wood.

### BACKGROUND OF THE INVENTION

When selecting waste wood materials, it is mainly necessary to first identify and then remove the pollutants present amongst the recycled wood coming from pallets, fruit crates and suchlike, cabinets, items of furniture, etc.

The pollutants can manifest in the mass of material to be selected, during the selection step, with the portion that qualifies them as pollutants disposed in any way and in any position whatsoever in the mass of wood material.

Therefore, the invention provides a selection that is aimed at obtaining a product without contaminants starting from a recycled product, derived as described above, including plastics, rubbers and wood-plastic mixed pieces.

It is known that the most common system used to select this type of material (plastics, rubbers, melamine-coated wood, plastic etc.) consists of a selection system consisting of a fast conveyor on which the mass of material to be selected is fluidified, while the conveyor advances at a normally constant speed, an optical detection system and a compressed air expulsion system, governed by a control and command unit.

The contaminants that can be present, and that have to be eliminated, are of various types.

Therefore, there may be items of furniture or of other origin that still have the ennobling coating made of plastic, metal, or painted, which is insensitive to magnetic forces, and above all are positioned in any manner and position whatsoever in the vehicle that moves them.

There may therefore be products, such as black rubber or plastics, which are inherently insensitive to highlighting since they absorb light without returning it.

There may also be pollutants such as metals, inert materials, melamine-coated wood, and more.

There are contaminating products that do not move in unison like the others but bounce and/or roll, and therefore travel at a lower, or in any case different, speed compared to the overall mass that advances.

In order to obtain a certain selection of the product to be eliminated, the invention provides that the expulsion action takes place with a top-down firing system, that is, from the top downward. Doing so eliminates possible conditions in which the control and command unit is deceived, which arise when defining the delay between the time of detection and that of expulsion.

There are contaminants whose portion which has the mean for identifying it as a contaminant is located in any position whatsoever with respect to the flow of products to be selected, that is, it can be positioned both upward and also downward, or toward the belt.

It is clear that, for example, if resin-bonded fiber panels are to be obtained with the wood waste, each contaminant of the type identified above affects the quality of the product, in particular of its surface.

The fact that there are plastic contaminants among the chips is therefore a serious problem for manufacturers of MDF panels, and partly for chipboard producers.

From patent documents WO 97/46328, U.S. Pat. No. 5,692,621 and EP 375 059, systems for sifting loose and incoherent material are known which use viewing systems, for example cameras, disposed above and below a transport element, to identify intruding and polluting elements to be removed from the flow of material. An unsolved problem in these documents is that the viewing systems, in particular the one located under the transport element, are very quickly dirtied by dust, sawdust, and other dirt, and can also be damaged by small fragments and pieces that fall and/or bounce from the transport element during transit.

Another unsolved problem is that related to the possibility of triggering a combustion due to the fact that dust or wood fragments or sawdust can come into contact with overheated parts, for example a glass that heats up due to the proximity of high power light sources associated with the viewing system.

These and other problems related to the presence of contaminants are solved by the invention in the manner which will be explained below.

The present invention therefore aims to solve these problems by means of a selection which can be even very fast, and which above all effectively meets expectations, and guarantees a quality end product.

Known plants are not able to treat these contaminants at a high level, and furthermore they normally travel at low speeds, making the selection that has to take into account the final price of the usable product too expensive.

It is therefore one purpose of the present invention to allow to select, starting from discarded wood products (pallets, items of furniture, fruit boxes and other similar and comparable items), those contaminating components that have characteristics not suitable for subsequent use.

A second purpose is to be able to make the selection at high speed, which allows to reduce the costs of the plant, management costs and therefore those of the final product.

It is another purpose to be able to carry out the selection, with a very high degree of precision, in whatever position the contaminants are and move into.

It is another purpose of the invention to prevent dirt and/or damage problems that can compromise the correct functioning and efficiency of the viewing systems, in particular the lower one.

Another purpose is to avoid risks of combustion or even only partial burns due to dust, fragments or small pieces that come into contact with overheated parts of the viewing system.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a selection machine according to the present invention comprises, in a known manner, a hopper, or suchlike, for delivering the material to be selected.

The hopper cooperates, according to a mode defined on each occasion based on the waste products to be selected, with a conveyor belt which, according to the invention, travels at a speed which is normally, although not necessarily, higher than the feed speeds of the analogous systems of the state of the art.

These speeds can even reach 8-10 m/s and more, so that the invention is able to work up to 22-24 tons/h of products which individually have an extremely low weight, and which occupy a space that reaches at most up to 100 mm with a width of about 20/30 mm.

The products to be selected, according to the invention, have a specific weight (apparent density) of around 150/200 kg/m³.

The speed selected, as well as reducing times and costs, tends to fluidify the material to be selected which is delivered by the hopper as above. Fluidification allows to prevent the presence of accumulations and piles on the conveyor belt, which hinder the correct viewing of the various components inside the moving mass.

For certain products to be selected, the conveyor belt, or at least part of it, can be associated with vibrating means before the machine. According to one variant, possibly able to be associated with the presence of the vibrators, in the case of products to be selected which by their nature tend to bind together, means can be present, in cooperation with the belt, which separate the accumulations or piles of material to be selected.

In the case of masses of material to be selected that are difficult to break up, the invention therefore also provides additional break up means upstream of the hopper, or which cooperate with the exit of the hopper.

According to the invention, the speed that allows to fluidify the components in the zone to control the contaminants is advantageously chosen on each occasion.

Downstream of the conveyor belt, in a known manner, there is a station for reading each component of the mass of material present on the belt.

According to the invention, at least two selection stations are provided, one which operates on the upper part of the material to be selected and one which operates on the lower part.

According to a first formulation, the reading station has light sources that have a constant spectrum in the infrared region (900-1700 nm), typically halogen.

According to the invention, advantageously, the light emitted has a constant spectrum also in the visible region (400-700 nm) so that the camera calibrated to detect within this range supplies a signal certain of the presence of plastics and organic compounds, which generally have a well-defined spectrum that identifies them in that region.

According to the invention, each reading station comprises a viewing system. Each viewing system comprises at least one camera associated with its own lighting system equipped with protective glass.

According to the invention, at least for the reading station disposed below the conveyor belt, a protection system is provided comprising at least one pneumatic system for cleaning the glass.

In one formulation of the invention, the pneumatic system comprises an element that emits an air barrier, continuous or periodic, substantially for the entire length of the glass, such as to determine the removal of particles, dust or other contaminant that could fall from the conveyor belt onto the glass itself.

In another formulation, as an alternative or in addition to the air barrier, a compressed air nozzle is provided mounted on a pneumatic cylinder provided with alternate motion for the removal of particles and pieces of a certain size from the glass. The alternate motion of the pneumatic cylinder can be timed with a certain frequency or, in an evolutionary variant, it can be governed by the detection, by suitable sensors, of the presence of particles or pieces larger than a certain size.

In another formulation, as an alternative or in addition to the solutions indicated above, it is provided that the lamps are equipped with a suitable air or water cooling system, with the aim of lowering their operating temperature.

According to one variant, in the case of heterogeneous products to be selected, two sources of differentiated light can be provided for each selection station.

In order to have a correct reading of the transiting material, the light cooperates with contrast means, so that the material to be selected passes between the light and the contrast means.

According to a first formulation, there is a point reader of the reflected light that decrypts its characteristic and therefore recognizes the contaminants through precise recognition programs.

According to another formulation, the contrast means are white which allows to also select black objects that would otherwise not be detectable.

The point reader cooperates, in terms of direct relation with the feed speed of the conveyor belt, with a line of ejectors-interceptors.

The ejectors-interceptors are located downstream of the detection stations and operate through point jets of air governed by the reading stations.

The ejectors have the task of intercepting and expelling those products that the point reading means recognize as contaminants.

According to the invention, the reading of the material that transits is carried out in a cadenced manner and can reach one scan per ms (advantageously in the range of 1 scan/ms, 1000 Hz) or even several scans per ms (e.g. 2 scan/ms, 2000 Hz)

The presence of the white contrast means causes the point readers to recognize black plastics or rubbers due to a difference in intensity.

According to an improved solution, there are two reading stations in series, each one designated to read a face of the material that transits, necessary to identify wood coated with plastic, melamine or paper (1 wood face, the other plastic, melamine or paper).

The invention also provides that a system for detecting metal materials is possibly present.

Advantageously, the system for detecting metal materials consists of at least one bar of inductive sensors.

The invention is also able to select intrinsically black products, such as rubber or plastic.

It should be noted that the speed of the belt is such that normally the products, at the exit of the belt, have a precise trajectory that passes through the control stations.

The Applicant has found that some pieces of polluting material do not travel at the speed of the belt, but move at a lower speed because they roll or in any case slide.

The invention therefore provides that, downstream of the exit from the belt, there is an ejection system that acts from the top downward, with two collection systems, of which the first dedicated to pollutants, the second to clean wood. In this way, the polluting materials which roll and deceive the control unit and the ejection system in the timing (delay between recognition and expulsion), still fall into the first collection system since they are slower than the main flow traveling at the speed of the belt

According to the invention, the management and control system correlates the speed of the belt, which as indicated can even reach 10 m/s or more, with all the other functions.

According to the invention, there is a direct and continuous relation between all the functions, since the speed of movement of the conveyor belt is determining and influencing.

### ILLUSTRATION OF THE DRAWINGS

These and other aspects, characteristics and advantages of the present invention will become apparent from the following description of some embodiments, given as a non-restrictive example with reference to the attached drawings wherein:

FIG. 1 is a schematic lateral view of a selection machine for wood material provided with an apparatus for selecting wood material according to embodiments described here;

FIG. 2 is a schematic view of the apparatus for selecting wood material of FIG. 1;

FIGS. 3 and 4 show two views of a viewing unit able to be used in the selection machine for wood material of FIG. 1.

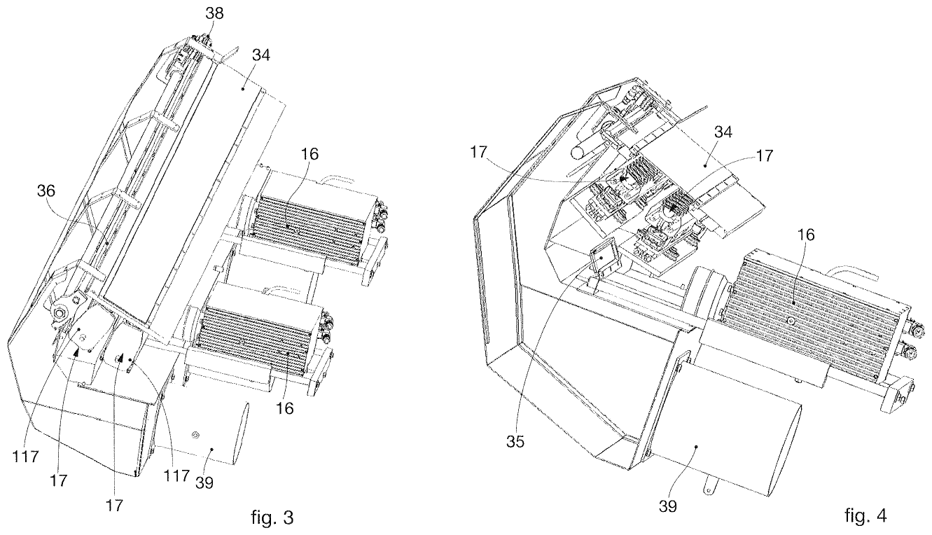

To facilitate comprehension, the same reference numbers have been used, where possible, to identify identical common elements in the drawings. It is understood that elements and characteristics of one embodiment can conveniently be incorporated into other embodiments without further clarifications.

### DESCRIPTION OF EMBODIMENTS

We will now refer in detail to the various embodiments of the invention, of which one or more examples are shown in the attached drawings. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

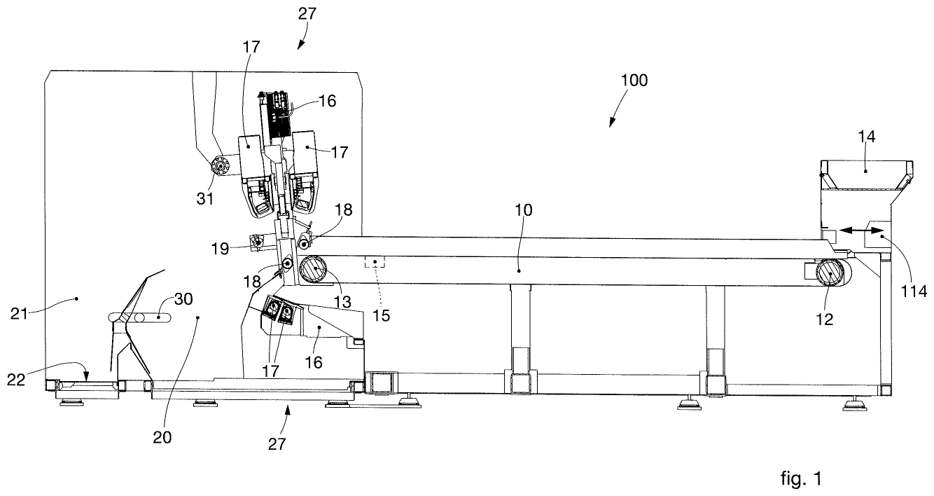

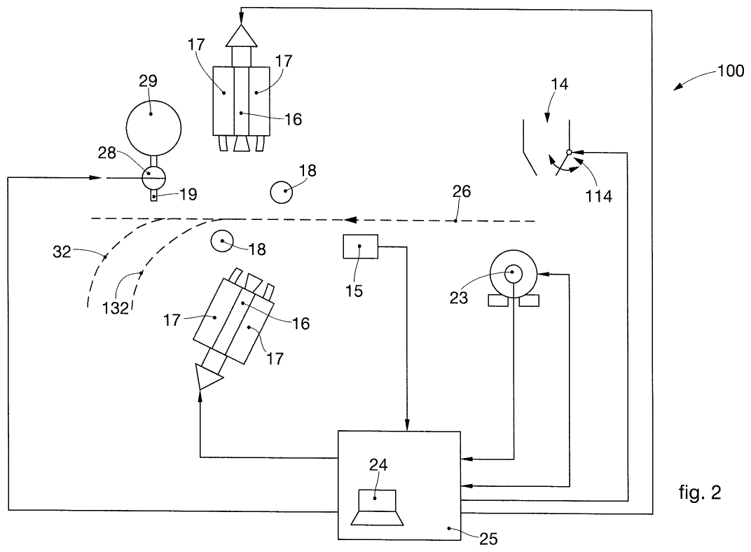

A selection machine according to the present invention is indicated as a whole with reference number 100 in FIGS. 1 and 2.

The selection machine 100 comprises a hopper 14, which according to the chosen solution has means 114 for regulating, on each occasion, the flow rate of the material, that is, acting on the speed of a conveyor belt 10. In this way, the desired quantity (see FIG. 2) of loose and incoherent material to be selected is unloaded onto the conveyor belt 10, which travels at the desired and set speeds 26 by means of a motor member 23. The speed 26 can be adjusted in relation at least to the type of material to be selected, and/or to the presence of accumulations, piles or lumps detected by suitable detectors, not shown.

A control and command unit 25, which possibly has control and regulation means 24, governs and controls the various devices.

The devices, in a synthesis sufficient to explain, by way of example, the invention, consist of various components.

The conveyor belt 10 cooperates with tail rollers 12 and head rollers 13, and can have means for regulating its tension. The conveyor belt 10 can cooperate directly at least with bars of sensors 15 which are, advantageously but not exclusively, inductive, in order to detect at least the presence and/or position of metal contaminants in the mass of wood material advancing on the conveyor belt 10.

In cooperation or correspondence with the exit of the conveyor belt 10, there are two stations 27 for identifying plastic materials or wood-plastic compounds to be discarded, respectively above and below the trajectory of the materials to be selected.

At least one bar of nozzles 19 that deliver, on command, jets of compressed air cooperates with the stations 27. The nozzles 19 are fed, on each occasion and each one in a point manner, by electro valves 28 selectively driven by the control and command unit 25.

A conduit 29 of pressurized air feeds, on each occasion, the nozzles 19. The nozzles 19 are of the concentrated jet type.

The nozzles 19 are fed on the basis of the point signal which cameras 16 send to the control and command unit 25; the cameras 16, at least an upper one and a lower one, being part of the identification stations 27.

Even if only one control and command unit 25 has been mentioned, in practice there can be modules that together make up the control and command unit 25.

The control and command unit 25, or the respective modules, are able to be programmed in a fixed manner on each occasion by means of the control and adjustment means 24, possibly even located at a distance.

The two cameras 16, advantageously of the color and/or hyperspectral type, are managed, advantageously although not necessarily, in an independent manner but in relation to respective light sources 17.

The light sources 17 can emit a single luminous spectrum, or can be adjusted on each occasion in order to emit, even simultaneously, different light spectra in relation to the type of contaminants and/or wood to be cleaned.

The cameras 16 operate respectively from below and from above the flow of material to be selected, and are coordinated with the respective light source 17.

The cameras 16 operate advantageously in cooperation with a contrast 18 which advantageously has a white background, so that the material to be selected transits between the white background and the camera 16 which is assisted by the light source 17.

Advantageously, there is a camera 16 which covers the width of the transiting material.

According to one variant, for each side of the transit of the material to be selected, there can be two or more cameras 16 operating in parallel, where the width of the belt requires it, with respective light sources 17.

Associated with the light sources 17 there is at least one covering and protective glass 34. Instead, the cameras 16 cooperate with a mirror 35 thanks to which the images of the material thrown by the conveyor belt 10 can be filmed at the desired angle.

According to one aspect of the present invention, associated with the glass 34 there is an air barrier 36 which emits a jet of air, continuous or suitably timed, so as to keep the glass 34 itself constantly clean, and reduce the danger of combustion due to the contact between particles or small pieces of loose material and the glass 34 made incandescent by the temperature of the lamps 17. The air barrier 36 serves to prevent the glass 34 from being dirtied both due to the deposit of wet dust through the air barrier 36 and the controlled temperature cooling of the glass 34, and also due to the deposit of pieces of a certain size and weight, for example metals, inert materials, wood chips, etc.

Furthermore, it serves to prevent the dangers of combustion due to the contact between flammable material such as wood, both in the form of dust and chips, and the glass 34, which is in fact at a high temperature caused by the heating due to the use of high power halogen lamps 17, which are necessary for the NIR (Near Infrared) viewing system.

In turn, according to the invention, the lamps 17 are equipped with a thermostatically controlled water cooling system, by means of a cooler and water circulation in the lamp holder 117.

The combined use of the air barrier 36 and the water cooling of the lamps 17 allows to keep the temperature of the glass 34 very low, typically in the range of ambient temperature at 20° C., so as to prevent risks of combustion, or even a partial burning of the glass which would lead to a loss of efficiency in the reading.

Furthermore, the viewing system also comprises a nozzle 38 for the delivery of compressed air, mounted on a pneumatic cylinder provided with alternate motion. The delivery nozzle 38 is advantageously timed to emit a jet of air able to remove heavy bodies, for example pieces of wood, plastic or metal, which could fall from the conveyor belt 10 and remain on the glass 34. In one variant, the drive of the delivery nozzle 38 and/or of the pneumatic cylinder can also be governed by the detection by suitable sensors (not shown), for example optical, of the presence of heavy bodies on the glass 34.

A conduit 39 allows the entry of the ventilation air to be fed to the air barrier 36, while the compressed air nozzle is fed by an independent line of compressed air.

As indicated, in the proximity of the exit of the conveyor belt 10 there are inductive sensors 15 that detect the presence of metal contaminants.

The signals that come from the cameras 16 and from the inductive sensors 15 are processed by the control and command unit 25.

The control and command unit 25 is able to define, with an accuracy of about 3-8 mm, the position/size of each material in transit to be selected.

The signals, which are detected on each occasion by the control and command unit 25, are sent in a point manner to actuators of the electro valves 28 of individual nozzles 19 suitable to emit specific and point jets of compressed air, downstream of the conveyor belt 10.

Thanks to the specific jet of compressed air which acts on the specific contaminant, this is displaced from its natural trajectory 32, indicated with dashed lines in FIG. 2, and moves to another trajectory 132, then falling into an area 20 designated to receive the contaminants.

The longitudinal definition of this area 20 is able to be adjusted by means of adjustment means 30 according to the speed 26 of the conveyor belt 10 and the pre-eminent type of contaminant.

Where there are contaminants that roll, or bounce, on the conveyor belt 10, these fall into the area 20 designated to receive the contaminants since they have a lower speed than that of the conveyor belt.

Similarly, the products deemed non-contaminating by the system fall into an area 21 possibly served by evacuation means 22.

Means 31 for adjusting the position of the identification stations 27 are advantageously provided.

It is clear that modifications and/or additions of parts or steps may be made to the selection machine as described heretofore, without departing from the field the present invention as defined by the claims.

It is also clear that, although the present invention has been described with reference to some specific examples, a person of skill in the art shall certainly be able to achieve many other equivalent forms of machine or method for selecting contaminants from a mass of wood material, having the characteristics as set forth in the claims and hence all coming within the field of protection defined thereby.

1. A selection machine for wood-type waste products to produce panels, comprising:
a delivery hopper and a conveyor belt on which a flow of wood material to be selected advances,
wherein at the exit of the conveyor belt there are at least two identification stations, of which at least one located below the conveyor belt, having at least one light source and at least one camera each cooperating with a respective contrast element, said identification stations being opposite and located astride the transit of the material to be selected, said camera being associated to a respective lighting system equipped with a protective glass and being governed by a control and command unit which, by means of recognition programs, conditions the drive of point nozzles operating on the flow of material exiting from the conveyor belt to remove contaminating materials from said flow characterized in that at least the identification station located below the conveyor belt comprises a protection system comprising at least a pneumatic system for cleaning said glass.

2. The selection machine as in claim 1, characterized in that said pneumatic system comprises an element that emits an air barrier, continuous or periodic, substantially for the entire length of the glass, such as to determine the removal of particles, dust or other contaminant that could fall from the conveyor belt onto the glass itself.

3. The selection machine as in claim 1, characterized in that it comprises a compressed air nozzle mounted on a pneumatic cylinder provided with alternate motion for the removal of particles and pieces of a certain size from the glass.

4. The selection machine as in claim 3, characterized in that said alternate motion of the pneumatic cylinder is governed by the detection, by suitable sensors, of the presence of particles or pieces larger than a certain size.

5. The selection machine as in claim 1, characterized in that said light source is associated with an air or water cooling system.

6. The selection machine for waste products as in claim 1, characterized in that the contrast element is white.

7. The selection machine for waste products as in claim 1, characterized in that the light source emits at least one light radiation in the near infrared.

8. The selection machine for waste products as in claim 7, characterized in that the cameras read in the region in the near infrared.

9. The selection machine for waste products as in claim 1, characterized in that at least one bar of inductive sensors is present along the conveyor belt, governed by a control and command unit and that commands nozzles that operate from the top downward.

10. The selection machine for waste products as in claim 1, characterized in that the nozzles are fed by pressurized fluids by means of an electro valve governed by a control and command unit.

11. The selection machine for waste products as in claim 1, characterized in that said conveyor belt is configured to advance at a speed in the range of 8-10 m/s.

12. The selection machine for waste products as in claim 1, characterized in that the hopper has means to control the flow rate of the material discharged onto the conveyor belt.

13. The selection machine for waste products as in claim 1, characterized in that the adjustment of the flow rate is defined by acting on the speed of the conveyor belt.

14. The selection machine for waste products as in claim 1, characterized in that at least one identification station cooperates with position adjustment means.

15. The selection machine for waste products as in claim 1, characterized in that two different selective reception zones are present downstream of the conveyor belt.

16. The selection machine for waste products as in claim 15, characterized in that it comprises means to adjust the longitudinal amplitude of said selective reception zone.

17. A method to select wood-type waste products to produce panels, the method comprising:
Feeding, by means of a conveyor belt, a mass of wood material
wherein, at the exit of the conveyor belt two opposite identification stations, comprising at least one light source, a camera and a respective contrast element, identify the presence of contaminating materials in the mass of wood material, and by means of recognition programs, activate nozzles to deliver compressed air operating on the flow of plastics and suchlike exiting from the conveyor belt to remove said contaminants from the mass of wood material and cause their separation, characterized in that it provides an operation of cleaning the glass at least of the identification station located below the conveyor belt by means of a pneumatic system for cleaning said glass.

18. The method as in claim 17, characterized in that it provides that said operation of cleaning the glass is carried out by emitting a flow of air through an air barrier, continuous or periodic, substantially for the entire length of the glass, such as to determine the removal of particles, dust or other contaminant that could fall from the conveyor belt onto the glass itself.

19. The method as in claim 17, characterized in that it provides that said cleaning operation is carried out by means of a compressed air nozzle mounted on a pneumatic cylinder provided with alternate motion for the removal of particles and pieces of a certain size from the glass.

20. The method as in claim 13, characterized in that the flow of compressed air, in order to remove the contaminating elements of the mass of wood material, operates from the top downward.

21. The method as in claim 13, characterized in that the cameras are operating in the field in the near infrared.
